(19) United States
(12) Patent Application Publication
(10) Pub. No.: US 2017/0320262 A1
(43) Pub. Date: Nov. 9, 2017

(54) METHOD AND APPARATUS FOR MANUFACTURING AN EMBOSSED SANDING SPONGE

(71) Applicant: AbraPower, Inc., Florence, KY (US)

(72) Inventors: Adam Tropiejko, Walton, KY (US); Barbara Tropiejko, Union, KY (US); Natasha Bowsher, Union, KY (US)

(21) Appl. No.: 15/582,917

(22) Filed: May 1, 2017

Related U.S. Application Data
(60) Provisional application No. 62/331,652, filed on May 4, 2016.

(51) Int. Cl. B29C 59/04; B05D 5/02; B05D 7/02; B24D 15/04; B29C 35/02; B29C 69/00; B05D 3/12; B29L 31/00; B29K 23/00; B29K 75/00; B29K 105/04

(52) U.S. Cl. CPC B29C 59/046; B29C 69/001; B05D 5/02; B05D 7/02; B24D 15/04; B05D 3/12; B29C 35/02; B29K 2023/083; B29K 2075/00; B29K 2105/04; B29L 2031/736

(57) ABSTRACT

A method and apparatus for manufacturing an embossed sanding sponge includes a first roller, a press base, and a conveyor. The first roller is mounted about an axis and configured to be rotatably driven about the axis. The first roller also includes a circumferential surface having a predetermined channel pattern. The press base is positioned proximate to the first roller and configured to compress the sponge material against the first roller. The conveyor has a support surface configured to translate and support the sponge material. In use, the circumferential surface of the roller engages the sponge material. The roller and the sponge material respectively rotate and translate in order to continuously press the predetermined channel pattern against the sponge material for manufacturing the embossed sanding sponge.

### PRIORITY

This application claims priority to U.S. Provisional Patent Application Ser. No. 62/331,652, filed May 4, 2016, entitled “METHOD AND APPARATUS FOR MANUFACTURING AN EMBOSSED SANDING SPONGE,” the disclosure of which is incorporated by reference herein.

### BACKGROUND

Sanding a surface, such as a drywall surface, with a sanding tool tends to generate a significant amount of dust and other debris that may be carried by the air. In turn, the debris spreads quickly throughout an area, forcing a user of the sanding tool and other nearby workers to breathe in the airborne debris and/or wear protective devices for reducing the likelihood of inhalation. Debris that is not inhaled eventually settles on surrounding surfaces throughout the area. While such debris may not be harmful, the user often must spend a significant amount of time and resources cleaning the settled debris from the area after completing the sanding process.

Prior attempts to reduce airborne debris generally include introducing a liquid, such as water, into the debris. For example, a sanding sponge may be wetted with water and then brought to the surface for sanding. The debris, particularly in the case of drywall dust, quickly absorbs the water, thus potentially decreasing the amount of debris that is carried into the air. While wetting the debris may help reduce the amount of airborne debris, the amount of debris continuously collecting on the sanding sponge significantly increases. Collected debris essentially clogs the porosity of the sanding sponge and reduces its effectiveness for sanding. In response to such clogging, sanding sponge manufactures may add channels in one of any number of patterns to the outer surfaces of sanding sponges. The channels are configured to receive the wetted debris and direct a flow of the wetted debris away from the outer surface in contact with the sanded surface for greater effectiveness.

Sanding sponge manufacturers generally form a predetermined pattern of channels on a sponge material by pressing the channels into the sponge material. For example, in the case of pressing the channels, the sponge material is arranged on a lower die directly underneath an upper die. The upper and lower dies move relatively vertically toward each other to squeeze the sponge material therebetween. One or both of the upper and lower dies are heated and may include the predetermined pattern, which is effectively pressed into the sponge material. Throughout the channel manufacturing process, the sponge material remains relatively stationary until the upper and lower dies completely form the predetermined pattern of channels. Upon formation of the predetermined pattern of channels, the sponge material may then be moved to other respective stations to receive adhesive and abrasive material, which is then cured. Still another station is configured to cut the sponge material to shape for use by the user on the sanding surface. While this discontinuous movement of sponge material allows for each step in the manufacturing process to essentially form an embossed sanding sponge for sale to the user, the manufacturing process and related equipment are relatively fragmented, requiring a time consuming, stop-and-go manufacturing process.

While a variety of manufacturing apparatuses and processes for manufacturing embossed sanding sponges have been made and used, it is believed that no one prior to the inventors have made or used an apparatus or process as described herein.

### BRIEF DESCRIPTION OF THE DRAWINGS

It is believed the present invention will be better understood from the following description of certain examples taken in conjunction with the accompanying drawings, in which like reference numerals identify the same elements and in which:

FIG. 1 depicts a perspective view of an exemplary manufacturing apparatus for manufacturing a plurality of sanding sponges;

FIG. 2 depicts an end view of a piece of sponge material passing through and being embossed by a first exemplary press roller as part of the apparatus of FIG. 1;

FIG. 3. depicts an end view of a piece of sponge material passing through and being embossed by a second exemplary press roller as part of the apparatus of FIG. 1; and

FIG. 4 depicts a perspective view of an exemplary sanding sponge manufactured by the apparatus of FIG. 1.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

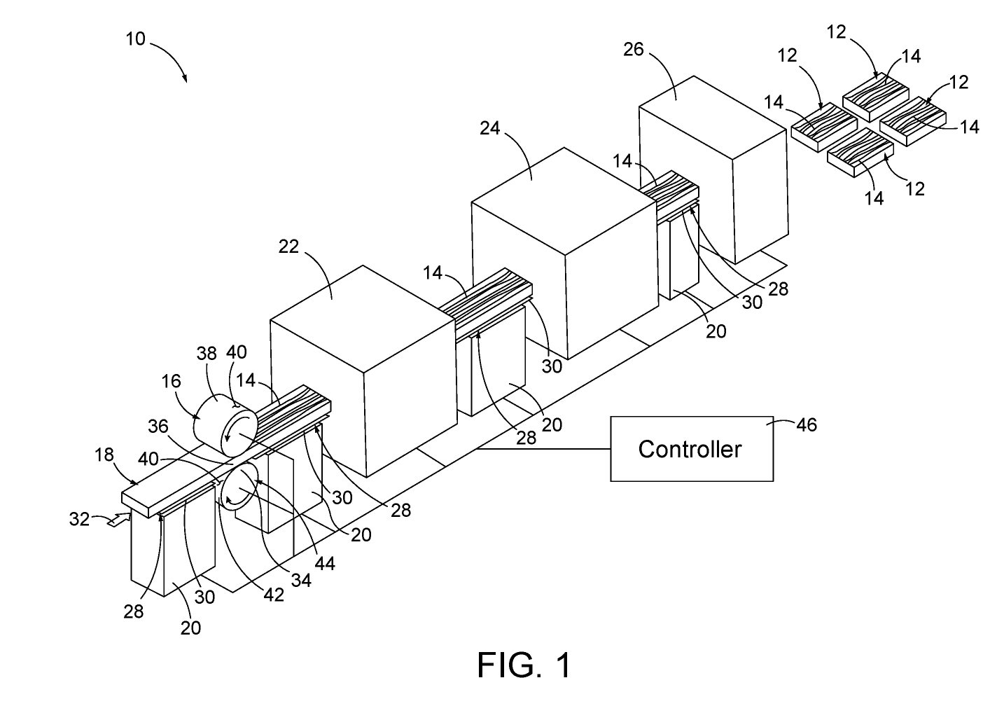

FIG. 1 illustrates an exemplary manufacturing apparatus (10) configured to manufacture a plurality of sanding sponges (12) embossed with a predetermined channel pattern (14). Manufacturing apparatus (10) includes at least one press roller (16) configured to receive an elongated strip of sponge material (18) thereagainst. By way of example only, sponge material (18) may comprise foam, including but not limited to polyurethane foam or crosslinked ethylene vinyl acetate (EVA) foam, or any other material suitable for a sanding sponge. Sponge material (18) is linearly fed to the press roller (16), which rotatably engages sponge material (18) to emboss a predetermined channel pattern (14) into a surface of an upper face of sponge material (18). As predetermined channel pattern (14) is continuously being embossed, sponge material (18) simultaneously translates onto a conveyor (20) for further operation such that manufacturing apparatus (10) fully forms sanding sponges (12) that may be ready for sale to an end user and/or customer of the manufacturer. In one example, press roller (16) may be configured to be heated and, upon contact with sponge material (18), emboss predetermined channel pattern (14) into sponge material (18). Alternatively, a portion of sponge material (18) may be removed by press roller (16) from the elongated sponge material (18) to emboss predetermined channel pattern (18) into sponge material (18) (e.g., press roller (16) could comprise a cutting roller). The term “emboss” is thus not intended to limit the invention to any particular type of predetermined channel pattern (14) formation and may include heating and deforming a portion of sponge material (18), removing a portion of sponge material (18), or any other suitable method of forming the desired channel pattern (14) in sponge material (18).

Manufacturing apparatus (10) further includes a combined adhesive and abrasive applicator (22), a curing device (24), and a sponge cutter (26). In one example, combined adhesive and abrasive applicator (22) is configured to apply a mixture of adhesive and abrasive material (e.g., a slurry) to the sponge material (18) along the embossed predetermined channel pattern (14). In some embodiments, the adhesive and abrasive applicator (22) may comprise a coating head, such as a slot die or roll coater, or any other device suitable to adequately apply the adhesive and abrasive material. Alternatively, the adhesive may be applied first with the abrasive material being applied thereafter. In another embodiment, the adhesive and abrasive material may be applied individually by two respective devices. In such an embodiment, the adhesive and abrasive material may be applied via known gravity fed or electrostatic application methods.

Curing device (24) is configured to efficiently and effectively cure the adhesive, thereby securing the abrasive material to sponge material (18) for sanding by the end user. In some embodiments, the curing device (22) may comprise an oven or any other device suitable to adequately cure the adhesive. Sponge cutter (26) receives sponge material (18) with the predetermined channel pattern (14) and abrasive material thereon. In some embodiments, the sponge cutter (26) may comprise one or more circular knives or band saws or any other device suitable to cut sponge material into the desired sections. Sponge cutter (26) is configured to cut elongated sponge material (18) into segments to form a plurality of embossed sanding sponges (12). In the present example, sponge cutter (26) cuts each sanding sponge (12) to a desirable length. However, it will be appreciated that any one or more desirable length sanding sponges (12) may be manufactured with sponge cutter (26). Sponge cutter (26) may also be configured to cut the elongated sponge material (18) into a desired width.

With respect to FIG. 1, press roller (16), adhesive and abrasive applicator (22), curing device (24), and sponge cutter (26) are operatively connected together by conveyors (20). Each conveyor (20) has a drive belt (28) with a support surface (30) configured to support the elongated sponge material (18) throughout manufacturing. More particularly, support surface (30) may translate in a continuous loop along a feed direction, indicated by arrow (32). Press roller (16), adhesive and abrasive applicator (22), curing device (24), and sponge cutter (26) are thus arranged in line with conveyors (20) being configured to translate the sponge material (18) therethrough in the feed direction (32). Due to the in line arrangement, press roller (16) is configured to continuously rotate and emboss sponge material (18), while adhesive and abrasive applicator (22), curing device (24), and sponge cutter (26) are configured to continuously receive and process embossed sponge material (18). Conveyor (20) thus simultaneously translates sponge material (20) while press roller (16) rotatably engages sponge material (20). Conveyor (20) may actively translate sponge material (20) or simply guide translation of sponge material (20) being directed in the feed direction (32). For example, press roller (16) in one example is rotatably driven by a motor (not shown). As press roller (16) engages sponge material (18) to emboss sponge material (18), press roller (16) also pushes sponge material (18) along conveyor (20) in feed direction (32).

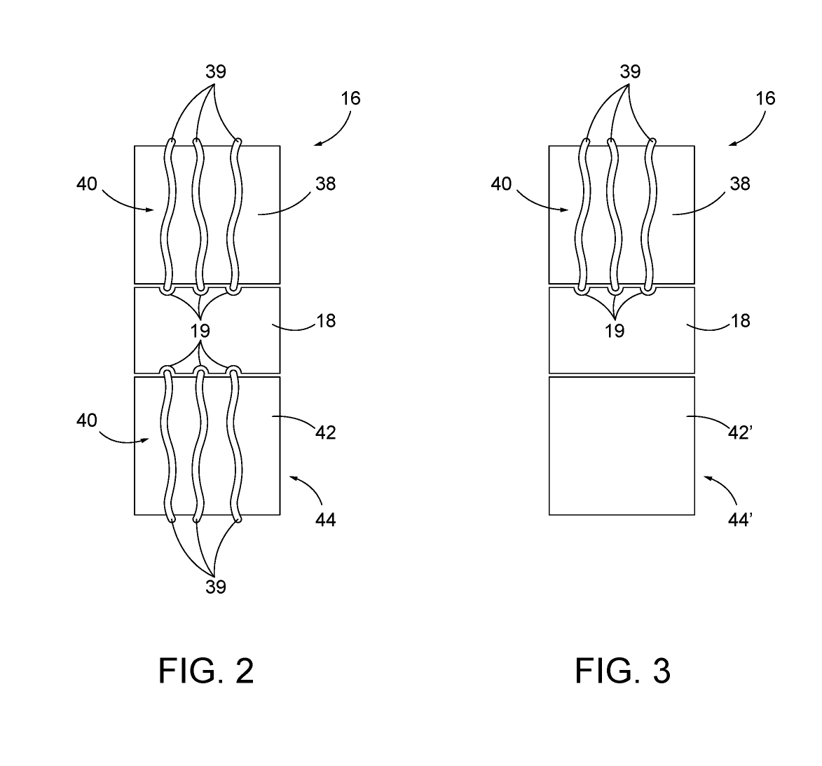

In order to support sponge material (18) while being embossed, a press base (34) is positioned proximate to press roller (16) to define a gap (36) therebetween. Sponge material (18) is fed into gap (36) such that press base (34) compresses sponge material (18) against a circumferential surface (38) of press roller (16), which includes a pattern (40) that is a negative of the predetermined channel pattern (14) that is desired for the embossed sanding sponge (12). In other words, the pattern (40) on circumferential surface (38) of press roller (16) is the opposite of the desired channel pattern (14). For example, in the embodiment shown in FIG. 2, circumferential surface (38) of press roller (16) includes a plurality of protrusions (39) that form corresponding depressions (19) in sponge material (18) as sponge material (18) passes through press roller (16). Pattern (40) may be engraved onto circumferential surface (38) of press roller (16) or applied to circumferential surface (38) using any other suitable technique. Circumferential surface (38) may be configured to be heated to a predetermined temperature to thermally form the predetermined channel pattern (14) into sponge material (18).

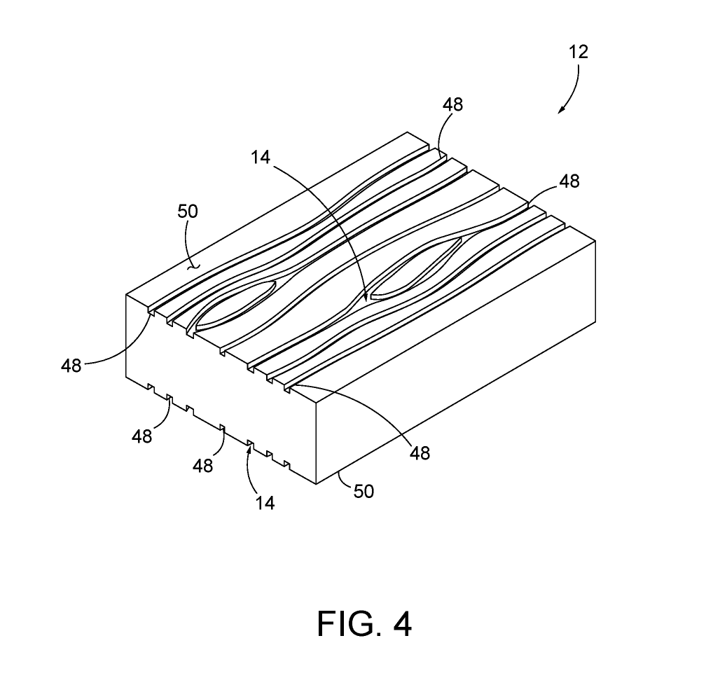

In the present example, press base (34) comprises an opposing roller (44) with its own circumferential surface (42). In other embodiments, press base (34) may comprise may comprise another structure suitable to compress sponge material (18) against roller (16), such as an anvil, guide or other suitable support surface. To this end, opposing roller (44) also includes negative predetermined channel pattern (40) on circumferential surface (42) for simultaneously forming predetermined channel pattern (14) on opposing sides of sponge material (18). Roller (44) is thus also configured to be heated to the predetermined temperature. In some embodiments, the pattern on circumferential surface (42) of opposing roller (44) may be the same as the pattern on the circumferential surface (38) of press roller (16), while in other embodiments the two patterns may be different. In still other embodiments, as shown in FIG. 3, circumferential surface (42′) of opposing roller (44′) may be substantially smooth to allow opposing roller (44′) to serve as an idler cylinder for supporting translation and compression of sponge material (18) during manufacturing. Such opposing roller (44′) as an idler cylinder thus does not emboss any pattern on the underside of the sponge material (18). In still other embodiments, additional rollers with patterned surfaces may be included to emboss patterns onto one or both of the lateral sides of the sponge material (18), instead of or in addition to embossing patterns on the top surface and/or bottom surface of sponge material (18) as described herein. Providing channels or patterns onto the lateral sides of the sponge material (18) may help improve the user's ability to grip the sanding sponge (12).

As shown in FIG. 1, each of rollers (16, 44), adhesive and abrasive applicator (22), curing device (24), and sponge cutter (26) may be operatively connected to a controller (46) configured to direct operation of manufacturing apparatus (10). By way of example only, controller (46) may be configured to control the application of adhesive and abrasive material as well as curing and cutting of sponge material (18) such that sponge material (18) continuously translates as rollers (16, 44) rotate. Controller (46) may thus continuously monitor and adjust the speed at which sponge material (18) translates, appropriate curing temperatures given speed of translation, and/or timing for cutting sponge material (18) via sponge cutter (26). Alternatively, instead of a single controller that controls all of the components of apparatus (10), each of the individual components may have their own individual controller or some other combination of components and controllers may be utilized. It will be appreciated that these general controls may be optimized for any particular materials and sizes used in the manufacturing process.

FIG. 4 shows one exemplary sanding sponge (12) with predetermined channel pattern (14) on opposing sides thereof. Predetermined channel pattern (14) generally includes a plurality of channels (48) configured to receive sanding dust and other debris to direct the debris away from a sanding surface (50) of sanding sponge (12). In the illustrated embodiment, the plurality of channels (48) generally extend parallel to the feed direction (32) (see FIG. 1) and define a faux wood pattern. As illustrated in this embodiment, the substantially continuous, inline embossing process allows for the creation of channels (48) that are oriented along the longitudinal axis or length (i.e., the largest dimension) of sanding sponge (12) such that when the sanding sponge (12) is cut from the strip of sponge material (18), the channels (48) are exposed on the front and back ends of the sponge (12). However, it will be appreciated any pattern and/or placement of channels for directing the flow of debris may be so used. The invention described herein is thus not intended to be limited to any particular pattern or channel. The predetermined channel pattern (14) may comprise a linear repeating pattern that can be oriented horizontally or vertically along sanding sponge (12). The predetermined channel pattern may comprise a geometric pattern, but it is not limited to geometric patterns, as demonstrated by the pattern (14) shown in FIG. 4. The channel pattern is repeated along the length of the strip of sponge material (18). In some embodiments, the pattern (14) may indicate the type of material to be sanded (e.g., a faux wood pattern for a sanding sponge to be used with wood, etc.). Furthermore, it will be appreciated that any sanding sponge material may be used, and the invention is not intended to be limited to any particular type of sanding sponge.

In one exemplary use, sponge material (18) is fed onto conveyor (20) and into gap (36) between rollers (16, 44) as shown in FIG. 1. By way of example only, in some embodiments during operation rollers (16, 44) may rotate at a speed of about 70 feet/minute to about 90 feet/minute. Rollers (16, 44) may rotate at the same speed as the conveyor (20) is running. In embodiments where one or both of rollers (16,44) are heated, the heated roller(s) (16,44) may be heated to the predetermined temperature and rotatably driven as press base (34) compresses sponge material (18) against press roller (16). By way of example only, in some embodiments, during operation, one or both of rollers (16,44) may be heated to a temperature of about 300 degrees Celsius to about 500 degrees Celsius. In embodiments where only one is used, then press base (34) may comprise another structure suitable to compress sponge material (18) against roller (16), such as an anvil such as an anvil, guide or other suitable support surface. The temperature of the roller may vary depending on certain application parameters, such as line speed and pattern depth. Each circumferential surface (38, 42) with negative predetermined channel pattern (40) engages sponge material (18) and thermally forms predetermined channel pattern (40) onto opposing sides of sponge material (18). Simultaneously, sponge material (18) continues to translate along feed direction (32) on conveyor (20). Conveyor (20) guides translation of elongated sponge material (18) inline through each of adhesive and abrasive applicator (22), curing device (24), and sponge cutter (26) in order to manufacture the plurality of embossed sanding sponges (12), as shown in FIG. 4. By way of example only, conveyor (20), or another equivalent means of transporting sponge material (18) through apparatus (10), may operate at speeds of about 70 feet/min to about 90 feet/min. Using an inline embossing process may allow for the creation of linear channels (e.g., channels that are aligned along the longitudinal axis of the sponge, wherein the longitudinal axis is oriented along the length or largest dimension of the sponge material (18)) in the sponge material (18) prior to the application of the adhesive and abrasive material, which allows the channels to be coated with adhesive and abrasive, thereby not exposing the sponge material below the surface of the sponge. The inline embossing process may also allow for the creation of a pattern that is contained to a central portion of the finished sanding sponge (12) such that the pattern is not embossed on the lateral/side edges and/or corners of the sanding sponge (12). Embossing the edges and/or corners of the sanding sponge (12) could result in weakened areas that are susceptible to increased wear and/or tearing.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of any claims that may be presented and is understood not to be limited to the details of structure and operation shown and described in the specification and drawings.

What is claimed is:

1. A method of manufacturing a sanding sponge comprising the steps of:
providing a roller, wherein the roller comprises a circumferential surface comprising a predetermined channel pattern;
engaging the circumferential surface of the roller against a sponge material; and
embossing at least one surface of the sponge material with the predetermined channel pattern by rotating the roller and translating the sponge material in a feed direction to continuously emboss the predetermined channel pattern on to the at least one surface of the sponge material.

2. The method of claim 1, further comprising applying an adhesive to the sponge material.

3. The method of claim 2, further comprising applying an abrasive material to the sponge material after the adhesive has been applied to the sponge material.

4. The method of claim 2, further comprising simultaneously applying an abrasive material and the adhesive to the sponge material.

5. The method of claim 2, further comprising curing the adhesive after the adhesive has been applied to the sponge material.

6. The method of claim 5, further comprising cutting the sponge material after the adhesive has been cured to form a sanding sponge.

7. The method of claim 6, further comprising continuously translating the sponge material while embossing, applying adhesive, curing, and cutting the sponge material.

8. The method of claim 1, further comprising heating the circumferential surface of the roller.

9. The method of claim 1, further comprising simultaneously rotating the roller and translating the sponge material.

10. A method of manufacturing a sanding sponge comprising the steps of:
providing a first roller, wherein the first roller comprises a first circumferential surface comprising a first predetermined channel pattern;
providing a press base positioned proximate to the first roller to create a gap between the first roller and the press base; and
embossing a first surface of a sponge material with the first predetermined channel pattern by rotating the first roller and translating the sponge material in a feed direction through the gap between the first roller and the press base such that the sponge material is engaged with the first circumferential surface of the first roller to continuously emboss the first predetermined channel pattern on to the first surface of the sponge material.

11. The method of claim 10, wherein the press base comprises a second roller.

12. The method of claim 11, wherein the second roller comprises a second circumferential surface comprising a second predetermined channel pattern.

13. The method of claim 12, further comprising embossing a second surface of the sponge material with the second predetermined channel pattern by rotating the first roller and translating the sponge material in a feed direction through the gap between the first roller and the press base such that the sponge material is engaged with the second circumferential surface of the second roller to continuously emboss the second predetermined channel pattern on to the second surface of the sponge material.

14. The method of claim 13, further comprising heating at least one of the first circumferential surface of the first roller and the second circumferential surface of the second roller.

15. The method of claim 14, further comprising heating both of the first circumferential surface of the first roller and the second circumferential surface of the second roller.

16. An apparatus for manufacturing an embossed sanding sponge, comprising:
a first roller mounted about an axis and configured to be rotatably driven about the axis, the first roller having a circumferential surface including a predetermined channel pattern configured to emboss a sponge material;
a press base positioned proximate to the first roller configured to compress the sponge material against the first roller; and
a conveyor having a support surface configured to translate and support the sponge material thereon for translating the sponge material away from the first roller,
wherein the first roller and the support surface are configured to simultaneously rotate and translate, respectively, for continuously moving the sponge material while manufacturing the embossed sanding sponge.

17. The apparatus of claim 16, wherein the circumferential surface of the first roller is configured to be heated for embossing the predetermined channel pattern into the sponge material.

18. The apparatus of claim 16, further comprising at least one of an adhesive applicator, an abrasive applicator, a curing device, and a sponge cutter, wherein the at least one of the adhesive applicator, the abrasive applicator, the curing device, and the sponge cutter are configured to receive the sponge material via the conveyer.

19. The apparatus of claim 18, further comprising at least two of the adhesive applicator, the abrasive applicator, the curing device, and the sponge cutter, wherein the first roller and the at least two of the adhesive applicator, the abrasive applicator, the curing device, and the sponge cutter are positioned in line.

20. The apparatus of claim 16, wherein the press base comprises a second roller.
